(19) United States
(12) Patent Application Publication
(10) Pub. No.: US 2010/0329497 A1
(43) Pub. Date: Dec. 30, 2010

(54) Speaker-transducer with its own Bass-Reflex and maximum efficiency cooling

(76) Inventor: Srdjan Perovic, Ottawa (CA)

Correspondence Address: Srdjan Perovic, 233-740 Springland Drive, Ottawa, Ontario, K1V 6L8, omitted

(21) Appl. No.: 12/495,787

(22) Filed: Jun. 30, 2009

(51) Int. Cl. H04R 1/20

(52) U.S. Cl. 381/349

(57) ABSTRACT

This is a novel speaker design which introduces its own internal bass-reflex. This design improves over existing designs in that it leads to acoustics that are more natural and of higher quality and, that it also leads to much improved cooling for the speaker's voice coil.

### BRIEF SUMMARY OF INVENTION

This is a new type of speaker which, for the first time introduces its own, internal bass-reflex. Moreover, this internal bass-reflex doubles as a maximum efficiency cooling mechanism for the speaker's voice coil. This novel design has a cooling effectiveness unsurpassed by anything currently available on the market. This design leads to acoustics that are more natural and of higher quality than achievable with existing speaker designs.

### BRIEF DESCRIPTION OF SEVERAL VIEWS OF THE DRAWING

FIG. 1 is a cutaway of the speaker design from the front-view perspective. The speaker is enclosed completely in a box (not shown in any figure). The speaker elements inside the box are: magnetic assembly (˜20), posts (˜31), speaker basket (˜30), cone diaphragm (˜50), springs covered in a rubber sheath (˜10 and ˜11), bass-reflex space (˜42), bass-reflex opening to outside (˜40) and bass-reflex opening to the inside of the speaker box enclosure (˜41).

FIG. 2 is an isometric view of the speaker basket (˜30), the posts (˜31) and the springs (˜10 and ˜11).

### DETAILED DESCRIPTION OF THE INVENTION

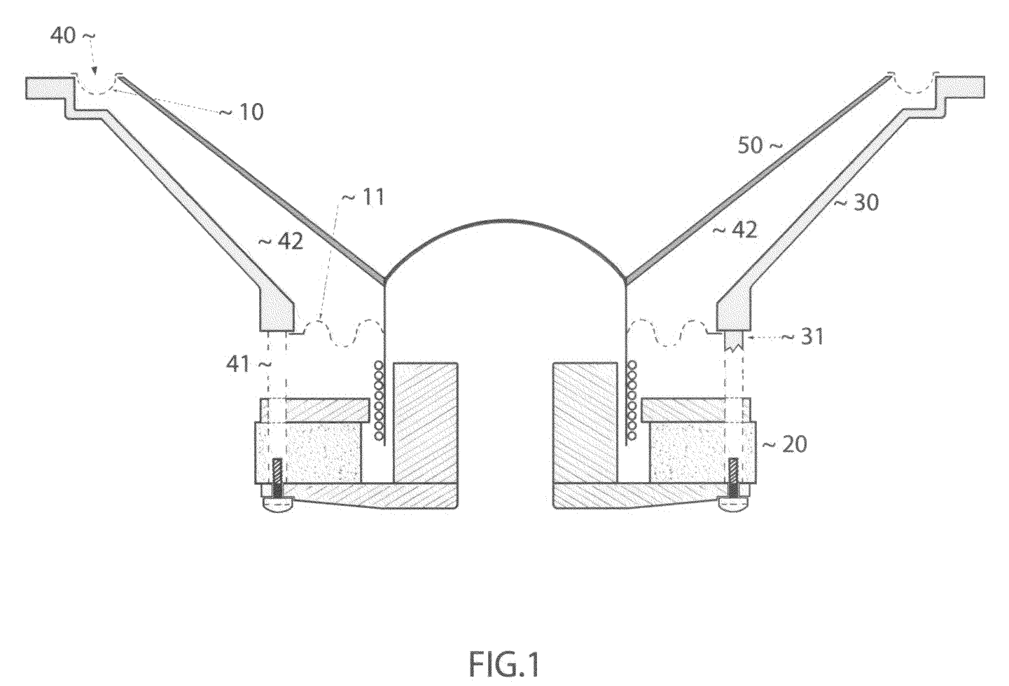

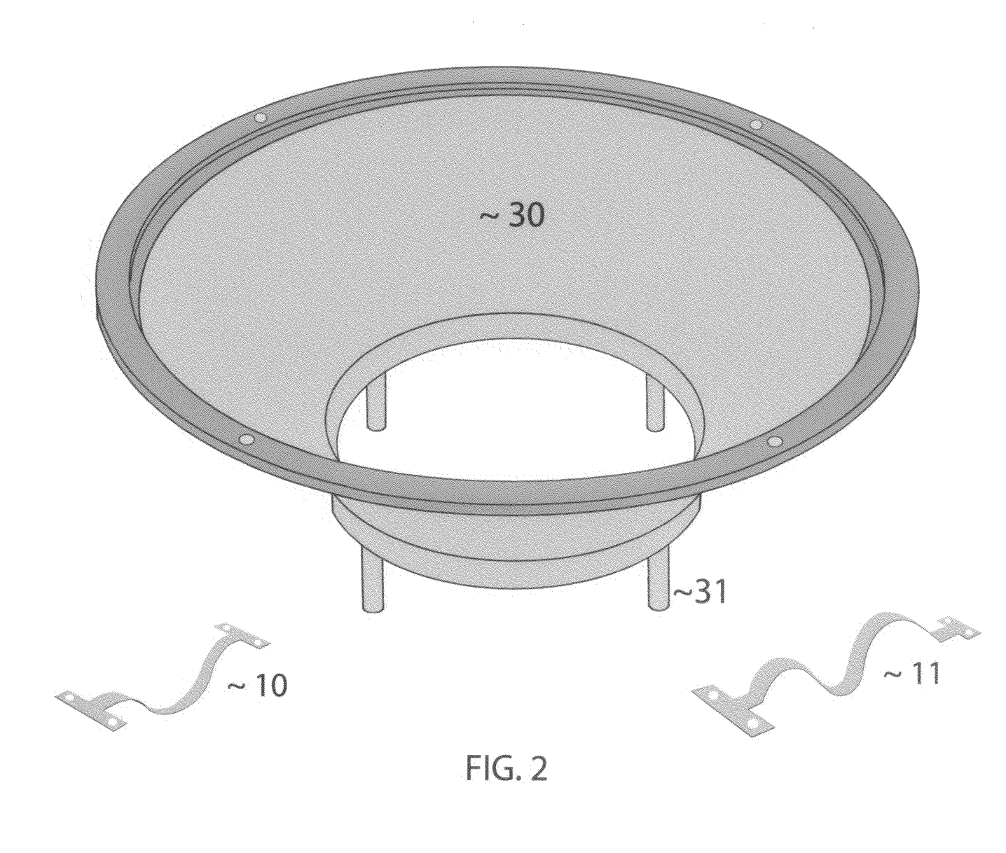

The basket of the speaker is molded like a cone without any openings (FIG. 2, ˜30), which together with the cone diaphragm (FIG. 1, ˜50) make the bass-reflex. To clarify, bass-reflex is the space enclosed between the basket (FIG. 2, ˜30) and the diaphragm (FIG. 1, ˜50).

The suspension of the cone diaphragm (FIG. 1 ˜50) is made of thin, flat metal springs covered in a rubber sheath (FIG. 1, ˜10 and FIG. 1, ˜11, and FIG. 2 ˜10 and ˜11) which are attached on one end to the cone diaphragm (FIG. 1 ˜50) and on the other to the basket of the speaker (FIG. 1, ˜30). The springs are uniformly distributed around the cone diaphragm (FIG. 1 ˜50) so that the air circulates freely from the outside, through the gap between the cone diaphragm (FIG. 1 ˜50) and the basket (FIG. 1, ˜30), and then into the speaker enclosure itself. The number of springs is a function of the size of the speaker, optimally that number is 8.

The posts seen in (FIG. 1, ˜31) and (FIG. 2 ˜31) physically separate the basket (FIG. 1 ˜30) from the magnetic assembly (FIG. 1, ˜20) and create and opening, bass-reflex, (FIG. 1 ˜41) towards the inside of the speaker enclosure. The opening is also one end of the bass-reflex.

The speaker needs to be in a closed box during the operation of the speaker and the vibration of the cone diaphragm (FIG. 1, ˜50). During the vibration of the cone diaphragm (FIG. 1, ˜50) the pressure rapidly rises and falls leading to equally rapid flow of air from the opening (FIG. 1 ˜40), through the gap between the cone diaphragm (FIG. 1, ˜50) and the basket (FIG. 1, ˜30), and then between the posts (FIG. 1, ˜31) and the openings (FIG. 1, ˜41) into the speaker enclosure. The airflow very efficiently cools the speaker's voice coil because of its exposure to the high rate of airflow. A small amount of that airflow passes though the pocket in the magnet and then the hole in the magnet, and, finally, into the speaker box. That additionally cools the voice coil and the magnet.

The springs (FIG. 1, ˜10 and FIG. 1, ˜11) have a small surface area and, therefore, present very little resistance to the airflow. The rubber sheath serves to cushion the sound generated by the springs themselves, which would otherwise create unwanted, interfering sound.

The size of the entry area of the bass-reflex (FIG. 1, ˜40) has to be the same as that of the exit area (FIG. 1, ˜41).

Given that currently there are no problems regarding over-heating of the voice coil, it is possible to make it smaller and lighter. The result of smaller vibrating mass is an improvement in the performance and the transients of the speaker.

1. This novel speaker design with internal bass-reflex improves the quality of sound over existing designs. Our bass-reflex design is composed of a) the space enclosed by the circular air gap (FIG. 1 ˜42) between the cone diaphragm (FIG. 1 ˜50) and the basket (FIG. 1 ˜30), b) an opening to the outside of the speaker box enclosure (FIG. 1. ˜40) and an opening to the inside of the speaker box enclosure (FIG. 1, ˜41). This design leads to acoustics that are more natural and of higher quality than achievable with existing speaker designs.

2. This novel design has a cooling effectiveness unsurpassed by anything currently available on the market. As far as cooling is concerned, our design adds to the traditional speaker design which uses a small amount of airflow that passes though the pocket in the magnet and then the hole in the magnet, and, finally, into the speaker box. In our design, we achieve a much higher quantity of additional cooling with the following design. The speaker is enclosed completely in a box, with only openings to the space outside the box being the air gaps between the top springs (FIG. 1, ˜10 and FIG. 2, ˜10). During the vibration of the cone diaphragm (FIG. 1, ˜50) the pressure rapidly rises and falls leading to equally rapid flow of air from the opening from the outside (FIG. 1 ˜40), through the bass-reflex space (FIG. 1, ˜42) enclosed between the cone diaphragm (FIG. 1, ˜50) and the basket (FIG. 1, ˜30), and then through openings (FIG. 1, ˜41) between the posts (FIG. 1 and FIG. 2, ˜31) and the into the box containing the speaker. The airflow very efficiently cools the speaker's voice coil because of its exposure to the high rate of airflow.

3. Unlike traditional suspension which generates parasitic frequencies and presents great resistance to vibration of the cone diaphragm (FIG. 1, ˜50), our design uses a new type of flat springs clad in rubber (FIG. 1, ˜10 and FIG. 2, ˜10): this technique manages both to avoid the generation of parasitic frequencies, as well as presenting smaller resistance to vibration or movement of the cone diaphragm.

4. The basket (FIG. 1 ˜30) is a novel and unique design constructed as a cast metal cone without any openings or holes.
